(19) United States
(12) Patent Application Publication
(10) Pub. No.: US 2002/0069203 A1
(43) Pub. Date: Jun. 6, 2002

(54) Internet information retrieval method and apparatus

(76) Inventors: Vinod K. Dar, Bethesda, MD (US); Frederick H. Abrew, McMurray, PA (US); Michaael S. Risssman, Pittsburgh, PA (US)

Correspondence Address: Gene A. Tabachnick, Esquire, Reed Smith LLP, P. O. Box 488, Pittsburgh, PA, 15230-0488, US

(21) Appl. No.: 09/915,224

(22) Filed: Jul. 25, 2001

Related U.S. Application Data
(60) Provisional application No. 60/220,539, filed on Jul. 25, 2000.

(51) Int. Cl. G06F 17/30

(52) U.S. Cl. 707/10

(57) ABSTRACT

A method and apparatus for retrieving information from a computer network such as the Internet includes a pre-selected and focused subset of all existing web sites that is searchable by the intended user. The invention preferably monitors the changes in content to the web sites in its database and notifies the user of such changes. A preferred embodiment allows the user to organize and index the search results according to various criteria selected by the user. A particularly preferred embodiment stores both current and historical web sites in its database and utilizes existing sites to find new sites to add to the database.

This application claims the benefit of provisional application No. 60/220,539 filed on Jul. 25, 2000.

### FIELD OF THE INVENTION

The present invention relates generally to an improved method and apparatus for searching distinct areas of interest on the World Wide Web.

### BACKGROUND OF THE INVENTION

The Internet dramatically changes the processes by which information is made available to decision-makers. The good news is that the Internet reduces the overhead involved in the publication and delivery of information. The bad news is that the Internet does so primarily by removing the value added through the screening or filtering process, essentially by transferring the labor involved from the old quality-control process to the decision-makers and their surrogates.

Simply put, the Internet allows authors to publish information directly to the World Wide Web without mediating quality-control actions by publishers and librarians. As a result, the Internet user of today is drowning in an ocean of information. The problem is steadily worsening each day as it becomes easier for someone new to put an additional item of information on the Web. The complexity of that information is increasing as broadband connections encourage users to publish huge files that are filled with complex, data-rich components. In its vastness, the Web is like an ocean fed by countless sources.

Search engines, the Web's equivalent to traditional indexing catalogs and document delivery systems, cannot contend with the rising tide of information. No search engine indexes all sites. Search engines are designed for the public at large, and as such, they tend to concentrate on sites of interest to the public at large and not on sites of interest to a specific professional community, such as the energy and utilities industry. Even then, there is too much information to index manually. A search engine searches for information about deregulation, for example, by looking for a string of letters that spell deregulation, and not for all the documents that are about deregulation. A search engine delivers the results as long lists of abstracts providing scant information about the underlying document. It is up to the researcher to visit the actual document. Search engines provide no convenient way to aggregate Web-based documents for further analysis or to monitor the arrival of new information.

The present invention seeks to address these problems by using a suite of integrated databases, interfaces and deep content navigation to deliver customized information to its users. For example, a user looking for information on energy companies' “termination of service terms and conditions” should only need to consider looking at energy company sites as primary sources of information and not the entire World Wide Web. The examples herein are described in the context of the energy and utilities community, but the invention could be applied to other areas of interest as well.

### SUMMARY OF THE INVENTION

The present invention is a centralized search tool designed to satisfy the search needs of Internet users in a specific field, such as energy and utilities. The present invention segments the World Wide Web in ways that enable the user to find and organize highly relevant information for their personal or professional use. Such segmentation facilitates access to a set of web pages satisfying a query. Additionally, the portal interface of the present invention helps shape the user's query in ways that ensure a high level of relevancy of the information being sought.

Generally, the present invention is an integrated web-based information system comprising a set of tools to help individuals and groups acquire, organize, manage, retrieve, control and share relevant information from the World Wide Web. These tools provide users with the capability to acquire information from pre-qualified and highly relevant web sites (including databases), to organize the information by building portals that represent a substrate of the voluminous information sources available on the World Wide Web that is highly relevant to the specialized needs of users, and to be notified when new, relevant information has been created or previous information has been modified. One of the tools characterizes potential web sites so that an informed decision can be made as to whether a site is worth adding to a portal. Sites may also be monitored for new and modified information. Additionally, collaborative authoring tools let users provide commentary on information contained in a portal and share this with other users.

The tool set is based upon an array of techniques developed by computer scientists, information scientists and other information professionals for acquiring, organizing, managing, retrieving and disseminating information. The set of tools is integrated into a system through graphical user interfaces that are easy for users to learn and use. The present invention understands the need to incorporate all the functions in the information-seeking and processing cycle and is developed using multiple techniques across multiple functions with the inclusion of human intelligence to provide a system that shows significantly improved efficiency and effectiveness.

### BRIEF DESCRIPTION OF THE DRAWINGS

FIG. 1 is a diagram showing the main components of an Internet information retrieval system according to the preferred embodiments of the invention.

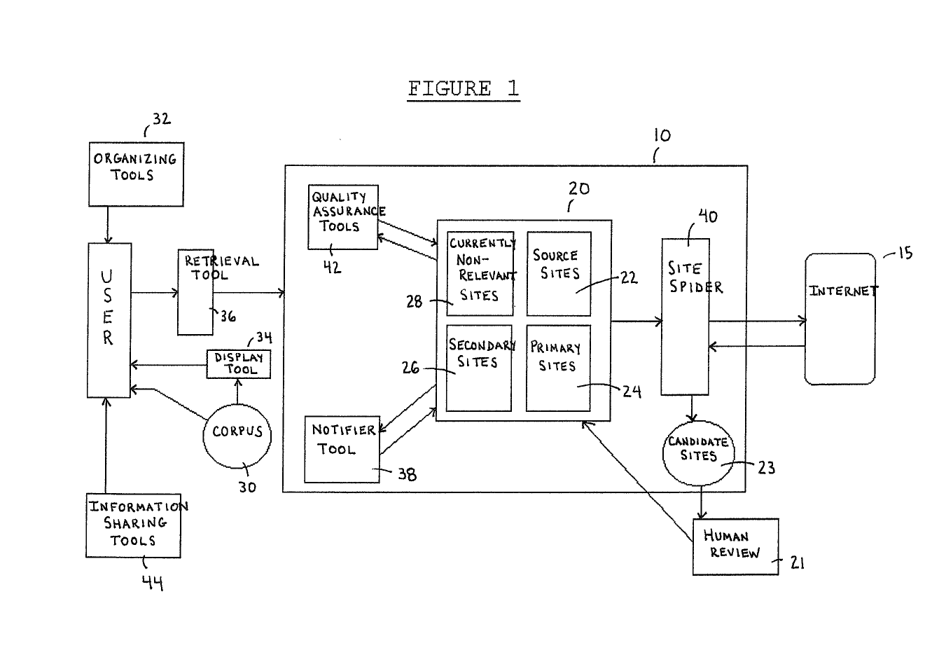

### DETAILED DESCRIPTION OF THE PREFERRED EMBODIMENT

The first step in the information-seeking and processing cycle is to identify from the Internet 15 the primary sources of information to satisfy a user's current or future information needs. The subset of web sites covered by the present invention is called the substrate 20, and the group of documents retrieved from those sites is called the corpus 30. The search engine 10 of the present invention locates sites to include in its substrate 20 as follows.

First, the search engine 10 is seeded with a set of sites called source or base sites 22. These source sites 22 are selected and placed in the substrate 20 after human review determines that their subject matter is likely relevant to the intended user of the search engine 10. The present invention preferably has a site spider 40 that uses the source sites 22 and a list of pre-defined concept terms and phrases to find those web sites that are candidates as primary sources 24 of information. Each time the search engine 10 examines a site placed in its substrate 20, it collects all hyperlinks from that site and adds unique links to a list of candidate sites 23. To facilitate human review 21 of the candidate sites 23, the search engine 10 extracts the text from the home page of the site. Human reviewers then examine the candidate sites 23 to determine whether or not they should be added to the substrate 20. Human reviewers may also use other more general search engines to fill any gaps or holes that they encounter in the substrate 20.

These primary sites 24 may have links to secondary sites 26 that are relevant in much the same manner that a journal article usually cites other highly relevant articles and books. These secondary sites 26 are examined and selected using the qualification conditions used for selecting the source sites 22. The site spider 40 gathers information helpful in evaluating the quality of a web site, and the search engine 10 gathers data regarding which of the identified sources are actually used by the user. Likewise, the tools that permit commentary on the information retrieved by or shared with others help to provide quality control as well as a source of evaluation of the data from the web site. This evaluative information can be used to delete or add web sites from or to the substrate 20 in order to minimize information overload and maximize relevance.

Not all web sites in the substrate 20 will contain information relevant to all users. Therefore an additional aspect of the preferred embodiment is to rate such sites as currently non-relevant sites 28 but sites that may be worthy of being monitored for the addition of relevant information in the future. If a currently non-relevant site 28 is considered a potential relevant primary source, its web pages are retrieved and stored in the substrate 20 for analysis, organization, and management as a precursor to the retrieval, notification, quality assurance, and sharing functions described herein. The site spider 40 helps guarantee that only a relatively small and highly relevant portion of the entire web is used for retrieving information for users. Therefore, the search engine 10 continues to acquire information from these sites until the system detects that the user is no longer interested in the information stored at a site. This is done by human or automated monitoring and reporting on the use of the system and providing the ability to change the information acquisition policy at any time.

Whereas the job of prior art search engines is complete upon retrieval of the information, with the present invention, analysis of retrieved information is facilitated by a number of organizing tools 32 that implement processes such as cataloging, concept extraction, classification, and indexing. In effect, the organizing tools 32 impose structure on unstructured documents, thereby making search and retrieval more relevant to the researcher's query. The organizing tools 32 provide multiple ways to organize the information for retrieval, notification, sharing and quality control.

This type of organization is akin to creating a textbook on a particular subject. Unlike the prior art, which merely displays retrieved information randomly, the present invention allows the user to layer a vertical structure around a group of sites as well as organize a set of documents in a fashion that facilitates the user's knowledge about a particular subject. Information can be organized by chapters and indexed by terms, thereby permitting retrieval of the information in the same way that one would obtain information from a book. The user can then do an analysis of the retrieved information by keyword or phrase indexing, thereby providing a view of the information in documents based upon the frequency with which certain words or phrases occur or co-occur with other words or phrases. An extension of keyword analysis keeps grammatical indicators and word/phrase location within a document to permit proximity and rudimentary natural language processing capabilities. Concept extraction analysis may use known statistical analyses, cluster analysis, pattern recognition, or natural language processing methods to provide a concept view of the information. The results of the analysis determine how the information can be retrieved and with what efficiency since data structures and database schemas are designed to accommodate the results of the analysis. For example, if a user wants information based on a keyword in the title of a document as opposed to the keyword anywhere in the document, the analysis must organize the information to accommodate this type of request. Likewise, if a user wants to define a concept to be searched for, then the analysis must provide the data and data structures to find relevant documents based on such concept.

It may also be preferable to combine the results of multiple queries into a digest. A user defines a digest by specifying a set of concepts and a set of sites. To facilitate location of sites, the present invention provides a site locator, which is a virtual directory of relevant retrieved sites searchable by various topics. For example, in the energy and utilities field, a user may search by company type, geographic region or company name. A digest preferably contains the following information for organizing and accessing its contents:

Site index

Topic index

Relevance, Date Added, Date Modified

Display of top summary or summaries

The present invention preferably represents each document as an abstract. Unlike prior art search engines, the present invention adds information to the abstract that often avoids the need to visit the document to judge its true relevance. Specifically, it preferably shows the following:

The title of the document

The name and owner of the site

A useful summary of the document

A list of the most important concepts covered by the document

The date the document was added to the collection and the date it

was last modified

A quantitative measure of the relevance of the document

The format type of the document

Because it only retrieves documents already stored in the substrate 20, the present invention preferably provides a display tool 34 to display a document's content without actually opening the web site. The display tool 34 quickly presents the full text of the document extracted by the search engine 10 and stored in the corpus 30. Thus, the user does not have to actually visit the page to examine it, or rely on the source site to be operational, or be forced to wait for irrelevant materials to load. The search engine 10 allows the user to load the actual page, but does not require the user to do so to examine its contents. In the full text, the display tool 34 highlights the terms satisfying the query. The display tool 34 also displays the document's most important concepts and highlights occurrences of individual concepts on demand.

A retrieval tool 36 provides for highly sophisticated searching utilizing powerful full-text searching in conjunction with the more traditional word and phrase indexing search. The retrieval tool 36 allows a user to find a highly relevant document and ask the search engine 10 to use it as a model for finding more similar documents. The search engine 10 will look in the substrate 20 first and then can be directed to search the entire Internet 15 for more documents like the model. These methods allow for high precision and recall in the retrieval process.

The present invention preferably makes a unique set of nuances available to its users. Consider the intent of a search for documents about deregulation. The present invention allows users to limit searches to documents published by a particular type of organization; e.g., a lawyer might be interested in information that public utilities commissions have published about deregulation. In contrast, a CEO might be interested in the unbundling of competitors to meet deregulation mandates. The present invention allows users to limit searches to organizations in a particular geographic area, or even to groups of companies favored by the user for one purpose or another.

The present invention is preferably constructed to track changes to the substrate 20. It builds its corpus 30 by regularly visiting sites, retrieving documents from the sites, and extracting text from the documents and embedded links from the documents. After visiting a site, it can be programmed to detect certain changes including:

Changes to a particular site

The addition of documents satisfying certain queries

Changes to particular pages, and ultimately to particular items on

a page

Once changes are detected, users can be notified by e-mail or upon log in.

For example, a notifier tool 38 monitors relevant sites for newly added information as well as information that has been changed for some reason. The challenge is to only report changes to important content and ignore simple changes such as a change in the spelling of a word. This type of service can not only save enormous amounts of time for users but reduces the cognitive overload imposed by most systems. The notifier tool 38 lets the user define which particular web sites the user is interested in, either by name or subject matter, and then automatically monitors the activity on those sites for the user. When the notifier tool 38 identifies a change occurring in the site, or identifies a new site that the user may be interested in, it automatically notifies the user that there has been a change and graphically displays what has changed. In this way users are certain that they are being kept up-to-date and that the coverage is as complete as they want it to be.

In much the same way that professional societies and other information professionals attempt to protect the user from information sources that are of poor quality, quality assurance tools 42 are provided to attempt to assess whether information at a source is of reasonable quality. In addition, information sharing tools 44 such as message boards or other online forums are provided to permit users to comment on information they retrieve from the database.

Others can share for comment via e-mail or bulletin boards documents that are retrieved and notifications of changes that are provided. This allows groups to share and evaluate information and information sources. If a source is providing information that does meet the users criteria of quality, it can be eliminated from the substrate 20.

Fragments of information from multiple documents can be cobbled together to produce a new document, if desired. Portions of documents can be extracted from the retrieval set and placed into a word processing or text file for consumption by one or more users.

Human intelligence is involved through a set of management tools, services and expert manual human intervention, when required. These tools and services provide the ability to define site characteristics, concepts, words, and terms for retrieving information as well as producing reports on user defined problems.

Traditional search engines do not consider the nature of the site publishing information. A document from a public utility commission about deregulation may be intrinsically different than a deregulation document on a utility's site. Furthermore, such a document on a competitor's site might be more important than a document on the site of a non-competitor. The present invention classifies sites, allows subscribers to define clusters of sites, and allows subscribers to use a site cluster as a filter on all queries.

The present invention preferably tracks most user actions. For example, it keeps track of what pages a user accesses. When displaying results of a query, it will include user-visit information in the presentation of the results. Depending on space, it might display other meta-information including the name of the site, a site-logo (as an incentive to publishers), and the like.

One advantage of the present invention over traditional generic search engines is that it features a clean, uncluttered interface, designed solely to facilitate information retrieval. If the present invention is funded by subscriptions, it does not have to clutter its interface with distracting advertising.

Another advantage is that present invention focuses only on sites intended to serve a particular interest, e.g., the energy community. No search engine covers the entire Web, and it is impossible for a search engine to recall documents not spidered into its corpus. Prior art search engines are general purpose, and it is difficult for search engines with general-purpose corpuses to recall only documents of interest to a specific professional community with precision. The present invention uses extensive domain knowledge to construct a substrate of sites intended for a specific pre-determined group, and uses a combination of domain knowledge and analysis tools not available to other search engines to keep the corpus consistent with the evolving needs of that group. It does so by reviewing both the queries of its users and the regularly-updated substrate for emergent concepts, and searching for sites addressing those concepts.

Another advantage is that the present invention finds documents satisfying the spirit of a submitted query. It preferably utilizes a thesaurus, knowledge of stemming, knowledge of morphemes, and a set of complex domain-specific concepts when searching its corpus for matches. It searches the full text of documents in the corpus, and searches every document in the corpus. It allows users to find documents like a particular document in the corpus or like a document on the user's desktop. The present invention can do all this because it uses a database system designed specifically to expedite full-text searching.

Another advantage is that the present invention is more timely than other search engines. Since it crawls only the substrate of relevant sites, it can retrieve new information from those sites more frequently than other search engines.

Another advantage is that the present invention recognizes individual users, and deals with the users as individuals. When listing corpus documents satisfying a query, it indicates whether the user has seen the document before. It also allows users to define user-specific complex search concepts and displays such concepts to the user for easy access.

Another advantage is that the present invention characterizes sites and allows users to restrict searches to particular types of sites. It keeps critical information about every site in its substrate. Users can define subsets of these sites, and restrict searches to sites in the specified subset.

Another advantage is that the present invention provides faster, more convenient access to documents in its corpus. It obtains textual information directly from its corpus and displays it directly without triggering the URL. The user does not have to deal with “dead” sites, wait for graphics to load, or toggle back to search results pages. The present invention allows the user to retrieve the actual page but does not require the user to do so. Additionally, because context is important, the present invention features a unique external site viewer that maps a document's site and provides access to the site's text without requiring a visit to the site.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. An Internet information retrieval method, comprising the steps of:
selecting desired sites to be searched by one or more users;
monitoring the desired sites to identify changes in content over time; and
reporting the changes in content to said one or more users when desired criteria are met.

2. The method of claim 1 wherein said desired sites relate to a common subject.

3. The method of claim 1 wherein said desired sites relate to the energy and utilities industry.

4. The method of claim 1 further comprising the step of displaying an abstract of the desired sites accessed by said one or more user.

5. The method of claim 1 further comprising the step of tracking the desired sites accessed by said one or more users.

6. The method of claim 1 wherein the text of the desired sites is stored in a database.

7. An Internet information retrieval method, comprising the steps of:
selecting desired sites to be searched by one or more users;
accessing one or more of the desired sites in response to a user-initiated query;
monitoring the desired sites to identify changes in content;
evaluating the changes in content to one or more of the desired sites; and
reporting the changes in content to said one or more users when desired criteria are met.

8. The method of claim 7 further comprising the step of organizing the desired sites accessed by said one or more users in a manner selected by said one or more users.

9. An Internet information retrieval apparatus comprising:
a retrieval tool for submitting queries;
a database containing a plurality of Internet web sites; and
a notifier tool for monitoring changes in the content of one or more of said plurality of web sites.

10. The apparatus of claim 9 wherein said database comprises current and historical web sites.

11. The apparatus of claim 9 further comprising a display tool for displaying one or more of said plurality of Internet web sites.

12. The apparatus of claim 9 further comprising information sharing tools for posting and exchanging information.
